(19) United States
(12) Patent Application Publication
(10) Pub. No.: US 2026/0188795 A1
(43) Pub. Date: Jul. 2, 2026

(54) SECONDARY BATTERY

(71) Applicant: SAMSUNG SDI CO., LTD., Yongin-si (KR)

(72) Inventor: Dae Kyu KIM, Yongin-si (KR)

(21) Appl. No.: 19/394,075

(22) Filed: Nov. 19, 2025

(30) Foreign Application Priority Data
Jan. 2, 2025 (KR) 10-2025-0000279

(51) Int. Cl. H01M 50/107; H01M 50/133; H01M 50/152; H01M 50/249; H01M 50/342; H01M 50/536; H01M 50/538

(52) U.S. Cl. CPC H01M 50/107; H01M 50/133; H01M 50/152; H01M 50/3425; H01M 50/536; H01M 50/538; H01M 50/249; H01M 2200/103

(57) ABSTRACT

A secondary battery which includes a cylindrical can having one end opened and the other end closed; an electrode assembly accommodated in the can; and a cap assembly including a upper cap disposed at the open end of the can, a lower cap spaced from the upper cap and disposed to face the electrode assembly, a vent plate disposed between the upper cap and the lower cap and surrounding the edge of the upper cap, an insulator made of an insulating material inserted between the vent plate and the lower cap, and a gasket made of an insulating material inserted between the vent plate and the can, wherein the lower cap may include a blocking part having a weld region that is welded to the vent plate and a fuse region that melts at a preset temperature and separates from the weld region.

### CROSS-REFERENCE TO RELATED APPLICATION

This application is based on and claims priority under 35 U.S.C. § 119 to Korean Patent Application No. 10-2025-0000279, filed on Jan. 2, 2025, in the Korean Intellectual Property Office, the disclosure of which is incorporated by reference herein in its entirety.

### BACKGROUND

### 1. Field

Embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable small electronic devices, such as smart phones, feature phones, notebook (laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

Embodiments of the present disclosure provide a secondary battery having a current blocking function due to internal pressure and a current blocking function due to temperature. These and other aspects and features of the present disclosure will be described in or will be apparent from the following description of embodiments of the present disclosure.

A secondary battery according to an embodiment of the present disclosure includes: a cylindrical can having one end opened and the other end closed; an electrode assembly accommodated in the cylindrical can; and a cap assembly including: a upper cap disposed at the open end of the cylindrical can, a lower cap spaced from the upper cap and disposed to face the electrode assembly, a vent plate disposed between the upper cap and the lower cap and surrounding the edge of the upper cap, an insulator made of an insulating material inserted between the vent plate and the lower cap, and a gasket made of an insulating material inserted between the vent plate and the cylindrical can, wherein the lower cap comprises: a blocking part having a weld region that is welded to the vent plate and a fuse region configured to melt at a preset temperature, the fuse region being separate from the weld region.

The upper cap may have a disk shape and includes a first region surrounded by the vent plate, a second region protruding in the opposite direction of the electrode assembly, and a third region connecting the first region and the second region and having a plurality of discharge holes penetrating therethrough.

The vent plate may have a disk shape and include a first portion positioned below the second region, an inclined surface extending upward from the first region, a second portion extending outward from the inclined surface and contacting a lower surface of the first region, a third portion extending from the second portion and contacting a side surface of the first region, and a fourth portion extending from the third portion and contacting an upper surface of the first region.

The lower cap may include a first support part positioned below the first portion, an inclined part extending upward from the first support part, a second support part extending outward from the inclined part and positioned below the second portion, and a connecting part extending inward from the first support part.

A thickness of the connecting part may be smaller than a thickness of the first support part.

The fuse region may extend from one side of the connecting part, and the weld region may extend from the fuse region.

The vent plate may further include a contact portion protruding from the lower surface of the first portion toward the lower cap.

The contact portion may be welded to the weld region such that the contact portion is electrically connected to the weld region.

The electrode assembly may further include a first electrode tab electrically connected to a first electrode plate, and a second electrode tab electrically connected to a second electrode plate of the electrode assembly.

The first electrode tab may be electrically connected to the closed end of the can, and the second electrode tab may be welded to the weld region of the blocking part such that the second electrode tab is electrically connected to the weld region.

In the blocking part, the weld region and the fuse region may have a same width.

In the blocking part, the width of the fuse region is smaller than the width of the weld region.

In the blocking part, a portion of the fuse region may have a smaller width than the weld region.

The blocking part may extend from one end to the other end of the connecting part and connects to the connecting part.

A portion of the blocking part may have a smaller width than other regions.

The weld region and the fuse region may be provided as one piece.

The blocking part may be provided as a plurality of block parts.

At least one notch may be provided in the first portion of the vent plate and the connecting part of the lower cap.

Preferably, a portion where the contact portion and the weld region are welded together, and a portion where the second electrode tab and the weld region are welded together, do not overlap each other.

The blocking part may be made of a different material from the lower cap.

The blocking part and a portion of the connecting part including the blocking part may be made of a different material from the lower cap.

The portion of the connecting part including the blocking part may overlap the connecting part to then be welded.

According to embodiments of the present disclosure, since a blocking part that breaks at a certain temperature or higher is provided in the lower cap, a current blocking function according to temperature can be provided while maintaining the current blocking function of a conventional vent that breaks according to the increase in the internal pressure. That is, both a current blocking function according to internal pressure and a current blocking functions according to temperature can be provided with a single cap assembly.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings illustrate embodiments of the present disclosure, and further describe aspects and features of the present disclosure together with the detailed description of the present disclosure. Thus, the present disclosure is not as being limited to the drawings:

FIG. 1 is a perspective view showing an exemplary secondary battery.

FIG. 2 is a cross-sectional view of the secondary battery according to FIG. 1.

FIG. 3 is an enlarged cross-sectional view of a cap assembly according to FIG. 2.

FIG. 4 is a plan view of a lower cap according to an embodiment of the present disclosure.

FIG. 5 is an enlarged plan view of main parts of FIG. 5.

FIGS. 6, 7, 8, 9, 10, 11, and 12 are plan views of a lower cap and main parts according to other embodiments of the present disclosure.

FIGS. 13 and 14 are perspective views showing a battery pack including an exemplary secondary battery according to the present disclosure.

FIGS. 15 and 16 are perspective and side views of a vehicle including an exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, a secondary battery according to embodiments of the present disclosure will be described in detail with reference to the attached drawings.

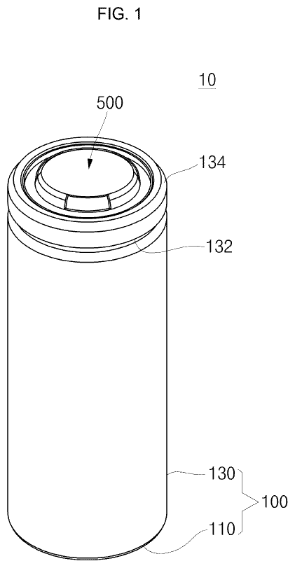

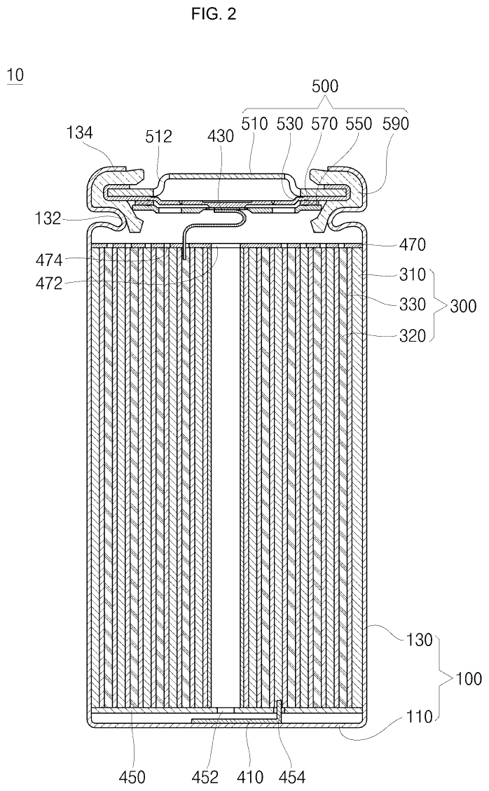

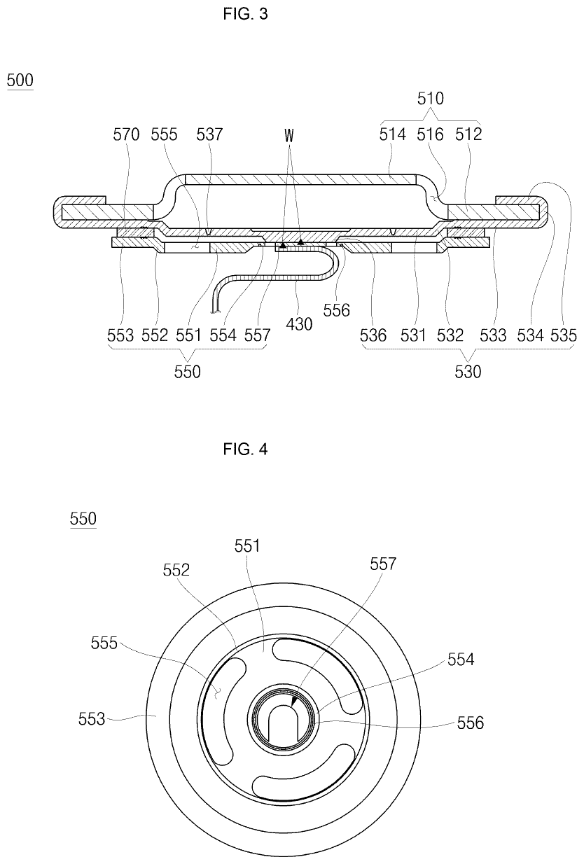

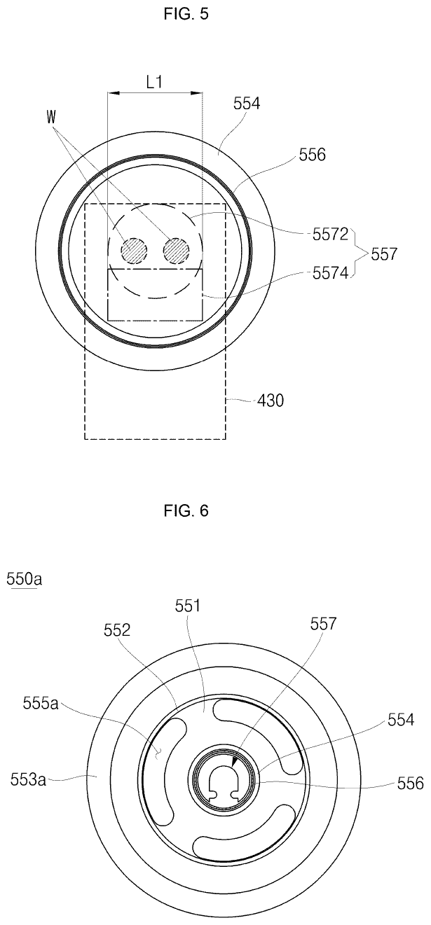

FIG. 1 is a perspective view showing an exemplary secondary battery. FIG. 2 is a cross-sectional view of the secondary battery according to FIG. 1. FIG. 3 is an enlarged cross-sectional view of a cap assembly according to FIG. 2. FIG. 4 is a plan view of a lower cap according to an embodiment of the present disclosure. FIG. 5 is an enlarged plan view of main parts of FIG. 5.

Referring to FIGS. 1 to 3, the secondary battery 10 according to an embodiment of the present disclosure may be a cylindrical battery. The secondary battery 10 may include a can 100, an electrode assembly 300, and a cap assembly 500. The electrode assembly 300 may be electrically connected to the can 100 and the cap assembly 500 by a first electrode tab 410 and a second electrode tab 430, respectively. In addition, a first insulation plate 450 may be disposed between the electrode assembly 300 and the can 100. A second insulation plate 470 may be disposed between the electrode assembly 300 and the cap assembly 500.

The can 100 constitutes the outer shape of the secondary battery 10 and may have a cylindrical shape with one end opened. The can 100 may include or be referred to as a case, a housing, or an exterior material. The can 100 may be provided with a metal such as steel, nickel-plated steel, a steel alloy, aluminum, an aluminum alloy, a deep-drawing cooling sheet (SPCE), or a laminate film or plastic material constituting a pouch. The can 100 may include a circular lower portion 110 and a cylindrical side portion 130 extending upward from the lower portion 110. The upper end of the side portion 130 may be opened, and the cap assembly 500 may be coupled to the opened end. In addition, a beading part 132 and a crimping part 134 may be provided on the upper end of the side portion 130. The present embodiment is described on the basis of an example in which the upper side of the can 100 is open, but conversely, the lower side may be open. The electrode assembly 300 may be accommodated inside the can 100 together with an electrolyte.

The beading part 132 may be provided so as to be concave inwardly adjacent to an end portion of the side portion 130. The crimping part 134 may be provided so as to be spaced apart from the beading part 132 and to have an end portion of the side portion 130 bent inwardly. The cap assembly 500, which will be described later, may be placed between the beading part 132 and the crimping part 134. Accordingly, the cap assembly 500 may be fixed so as not to be separated from the can 100 by the beading part 132 and the crimping part 134.

The electrode assembly 300 may include or be referred to as an electrode group, an electrode body, or a jelly roll. The electrode assembly 300 may include a first electrode plate 310, a second electrode plate 320, and a separator 330. In the electrode assembly 300, the separator 330 may be interposed between the first electrode plate 310 and the second electrode plate 320, which are wound in a cylindrical shape. In some examples, the electrode assembly 300 may have an approximately empty central region. The empty central region may also be referred to as a core 380. A cylindrical center pin (optional) may be inserted into the core 380 for supporting. The core 380 may serve as a passage through which pressure is discharged when the internal pressure of the secondary battery 10 becomes greater than a reference pressure. In some examples, when the internal pressure increases, the internal gas may rise through the core 380, causing a notch 537 of the vent plate 530, which will be described later, to be ruptured. The gas may then escape through the upper cap 510, which will be described later, thereby reducing the internal pressure of the secondary battery 10.

The first electrode plate 310 may be either a negative electrode plate or a positive electrode plate. The first electrode plate 310 may include a first substrate which is a metal thin plate, a first active material layer provided on at least one surface of the first substrate, and a first uncoated portion on which the first active material is not provided. The first uncoated portion may be referred to as a first substrate. The first electrode tab 410 may be electrically connected to the first uncoated portion. In an example, the first electrode plate 310 may function as a negative electrode. In this case, the first electrode tab 410 may function as a negative electrode tab. The first electrode tab 410 may be made of copper or nickel.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The second electrode plate 320 may be either a negative electrode plate or a positive electrode plate. The second electrode plate 320 may include a second substrate which is a metal thin plate, a second active material layer provided on at least one surface of the second substrate, and a second uncoated portion on which the second active material is not provided. The second uncoated portion may be referred to as a second substrate. The second electrode tab 430 may be electrically connected to the second uncoated portion. In an example, the second electrode plate 320 may function as an anode. In this case, the second electrode tab 430 may function as a positive electrode tab. The second electrode tab 430 may be made of aluminum.

Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The separator 330 is interposed between the first electrode plate 310 and the second electrode plate 320 and serves to prevent short circuit between the first electrode plate 310 and the second electrode plate 320.

For example, The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto. The organic material and the inorganic material may be mixed in one coating layer or may be in the form of a coating layer containing an organic material and a coating layer containing an inorganic material that are laminated on each other.

The electrolyte solution for a rechargeable lithium battery may include a non-aqueous organic solvent and a lithium salt.

The non-aqueous organic solvent may serve as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof, and may be used alone or in combination of two or more types. Additionally, when using a carbonate-based solvent, a cyclic carbonate and a chain carbonate may be used in combination.

The first insulation plate 450 has a plate shape and may be made of an insulating material. The first electrode plate 310, which is a negative electrode, is not electrically connected to the lower portion 110 of the can 100. That is, the first electrode plate 310 may not be in direct contact with the lower portion 110 by the first insulation plate 450. The first insulation plate 450 may have a first hole 452, which is in communication with the core 380, and a second hole 454, through which the first electrode tab 410 passes. The first hole 452 allows the gas to move toward the cap assembly 500 through the core 380 when a large amount of gas is generated due to abnormality of the secondary battery. The first electrode tab 410 may pass through the second hole 454 to then be welded to the lower portion 110. The first insulation plate 450 may be replaced with an insulating tape or an insulating sheet.

The second insulation plate 470 prevents the second electrode plate 320, which is a positive electrode, from being electrically connected to the cap assembly 500. That is, the second electrode plate 320 may not be in direct contact with the cap assembly 500 by the second insulation plate 470. The second insulation plate 470 may have a first hole 472, which is connected to the core 380, and a second hole 474, through which the second electrode tab 430 passes. The first hole 472 allows the gas to move toward the cap assembly 500 when a large amount of gas is generated due to abnormality of the secondary battery. The second hole 474 may be provided in multiple pieces. The second electrode tab 430 may pass through the second hole 474 to then be welded to the lower cap 550, which will be described later. In addition, the second hole 474 may serve as an inlet through which the electrolyte is injected into the electrode assembly 300 during an injection process.

Although not shown, other current collecting structures may be applied to the secondary battery of the present embodiment. That is, the first uncoated portion and the second uncoated portion described above may be notched in a certain shape to serve as the first substrate tab and the second substrate tab. The first substrate tab and the second substrate tab may be electrically connected to the first current collecting plate and the second current collecting plate, respectively. The first current collecting plate may be electrically connected to the can. The second current collecting plate may be electrically connected to the cap assembly in a state of being insulated from the can.

Referring to FIGS. 2 to 5, the cap assembly 500 may be coupled to the open end of the can 100. The cap assembly 500 may include a upper cap 510, a vent plate 530, a lower cap 550, an insulator 570, and an insulation gasket 590. The cap assembly 500 may be inserted between the beading part 132 of the can 100 and the beading part 132 through the insulation gasket 590. The upper cap 510, the vent plate 530, and the lower cap 550 may be formed of aluminum, an aluminum alloy, and an equivalent thereof, but the materials are not limited thereto.

The upper cap 510 is a portion exposed to the outside of the can 100 and may be arranged at the outermost portion (the uppermost portion on the basis of FIG. 2) of the cap assembly 500. In an example, the upper cap 510 may have a shape in which a portion protrudes convexly from a metal plate shaped of a disk. The convex region may be a central region of the disk. The vent plate 530 may be arranged at the bottom of the upper cap 510. The vent plate 530 may have a shape that surrounds the edge of the upper cap 510. For convenience, the edge region of the upper cap 510 is referred to as a first region 512, the protruding region is referred to as a second region 514, and the inclined region between the first region 512 and the second region 514 is referred to as a third region (not shown). In an example, a plurality of discharge holes 516 may be provided in the third region 516. The discharge holes 516 serve as passages through which gas moving through the core 380 is discharged.

The vent plate 530 may be shaped of a roughly circular disk and may have an edge that surrounds the first region 512 of the upper cap 510. The edge of the vent plate 530 may surround portions of a lower surface, a side surface, and an upper surface of the first region 512. Thus, the vent plate 530 may have a larger diameter than the upper cap 510. The vent plate 530 may include a first portion 531, an inclined surface 532, a second portion 533, a third portion 534, a fourth portion 535, and a contact portion 536. The notch 537 may be provided in the first portion 531.

A portion of the vent plate 530, positioned approximately below the second region 514 of the upper cap 510, may be referred to as the first portion 531. On the basis of FIG. 3, the inclined surface 532 may extend upward from an outer diameter portion of the first portion 531. The second portion 533 may extend outward from the inclined surface 532. The second portion 533 may come into contact with a lower surface of the first region 512 of the upper cap 510. The inclined surface 532 may connect the first portion 531 and the second portion 533 in a stepped manner. That is, the first portion 531 and the second portion 533 have a step with respect to each other. In an example, the first portion 531 may be relatively lower than the second portion 533 and close to the lower cap 550 on the basis of FIG. 3. The second portion 533 may be relatively higher than the first portion 531. That is, the inclined surface 532 may be a surface that is upwardly inclined on the basis of FIG. 3. The third portion 534 may be bent upward approximately vertically from the second portion 533. The third portion 534 is a portion that comes into contact with the side surface of the first region 512 of the upper cap 510. The fourth portion 535 may be bent approximately vertically from the third portion 534 toward the center of the upper cap 510. The fourth portion 535 may be in contact with a portion of the upper surface of the first region 512 of the upper cap 510. The contact portion 536 may be a region of a predetermined area that protrudes from the center of the lower surface of the first portion 531 toward the lower cap 550. Thus, the thickness of the first portion 531 provided with the contact portion 536 can be larger than the thicknesses of other portions. The contact portion 536 may come into direct contact with the lower cap 550 to then be welded. The welding position of the contact portion 536 and the lower cap 550 is indicated by W in FIG. 3 (W is only an exemplary welding position and is not limited to the position shown herein). The vent plate 530 does not come into contact with the lower cap 550 at portions other than the contact portion 536. That is, as the contact portion 536 protrudes, the first portion 531, the inclined surface 532, and the second portion 533 may be spaced apart from the lower cap 550. In addition, the insulator 570, which will be described later, may be inserted between the vent plate 530 and the lower cap 550. The first portion 531, the inclined surface 532, the second portion 533, the third portion 534, the fourth portion 535, and the contact portion 536 may be provided as one piece.

At least one notch 537 may be provided on the first portion 531 of the vent plate 530. The notch 537 may be spaced apart from the contact portion 536. In addition, the notch 537 may be positioned adjacent to the gas hole 555 of the lower cap 550, which will be described later. In an example, the notch 537 may be provided on the plate surface of the first portion 531 facing the upper cap 510, but may also be provided on the plate surface facing the lower cap 550. When the internal pressure of the secondary battery 10 increases, the notch 537 may be ruptured, thereby opening the vent plate 530. The opening of the vent plate 530 means a state in which the notch 537 is ruptured and the portion of the first portion 531 including the contact portion 536 is separated. The vent plate 530 forms a current path from the electrode assembly 300 to the vent plate 530 by electrically connecting the contact portion 536 to the lower cap 550 and the second electrode tab 430. However, when the vent plate 530 is opened, the current path is cut off as the contact portion 536 is separated from the lower cap 550. Thus, the notch 537 may have a current blocking function that is activated by pressure (e.g., internal pressure of a secondary battery).

Meanwhile, the lower cap 550 may have a roughly circular shape and a smaller diameter than the upper cap 510. The lower cap 550 may be arranged at the lower portion of the vent plate 530 with reference to FIG. 3. That is, the lower cap 550 is arranged on the inner side of the cap assembly 500 closest to the electrode assembly 300. The lower cap 550 supports the upper cap 510 and the vent plate 530 and prevents deformation of the upper cap 510 from external force. The lower cap 550 may include a first support part 551, an inclined part 552, a second support part 553, a connecting part 554, and a blocking part 557. At least one gas hole 555 may be formed through the first support part 551. At least one notch 556 may be provided on the connecting part 554.

The first support part 551 may be an area that is arranged approximately below the second region 514 of the upper cap 510 and the first portion 531 of the vent plate 530. The first support part 551 may be spaced apart from the first portion 531 of the vent plate 530. The inclined part 552 may be connected outwardly from the first support part 551.

On the basis of FIG. 3, the inclined part 552 may extend upwardly from the outer diameter portion of the first support part 551. That is, the inclined part 552 may be an area that is inclined upwardly from the first support part 551. The second support part 553 may extend outwardly from the inclined part 552. Thus, the first support part 551 and the second support part 553 may have a step with respect to each other.

The second support part 553 may be spaced apart from the second portion 533 of the vent plate 530. In addition, the second support part 553 may be approximately parallel to the second portion 533. In some embodiments, the lower cap 550 can have a smaller diameter than the vent plate 530. Accordingly, the length of the second support part 553 (the length in the left-right direction on the basis of FIG. 3) may be smaller than the length of the second portion 533 of the vent plate 530.

Referring to FIG. 4, the connecting part 554 may be a region extending from the inner diameter portion of the first support part 551 toward the center of the lower cap 550. In an example, the connecting part 554 may have a thickness (upper-to-lower thickness on the basis of FIG. 3) smaller than the first support part 551. More specifically, referring to FIG. 3, the upper surface of the connecting part 554 and the upper surface of the first support part 551 may be coplanar. Since the thickness of the connecting part 554 is smaller than the thickness of the first support part 551, the lower surface of the connecting part 554 may be connected with the lower surface of the first support part 551 in a stepped manner. That is, the lower surface of the connecting part 554 may be closer to the contact portion 536 of the vent plate 530 than the lower surface of the first support part 551. A notch 556 may be provided on the connecting part 554. The notch 556 may have the same function as the notch 537 of the vent plate 530. In an example, the notch 556 may be provided on the lower surface of the connecting part 554 facing the electrode assembly 300, but is not limited thereto. In addition, the connecting part 554 may have the function of connecting the blocking part 557 and the first support part 551.

Referring to FIGS. 4 and 5, the blocking part 557 may have a function of blocking a current path by heat. The blocking part 557 may be provided in various shapes. At least one or a plurality of blocking parts 557 may be provided as needed. The blocking part 557 may extend from an inner diameter portion of the connecting part 554. In an example, the blocking part 557 may extend in a rectangular shape, and its end may be semicircular. The blocking part 557 may be divided into a weld region 5572 and a fuse region 5574. The weld region 5572 and the fuse region 5574 are provided as one piece, and are separately designated for convenience. An exemplary weld region 5572 is indicated in a circular dotted line in FIG. 5. An exemplary fuse region 5574 is indicated in a rectangular dotted line in FIG. 5.

The weld region 5572 is a region where the second electrode tab 430 and the contact portion 536 of the vent plate 530 are welded. Each of the second electrode tab 430 and the contact portion 536 may be welded on the weld region 5572. In an example, the regions where the second electrode tab 430 and the contact portion 536 are welded do not overlap each other. In the weld region 5572, a portion to be welded with the second electrode tab 430 is indicated by W in FIG. 5 (the welding position where the second electrode tab and the lower cap are welded is also indicated by W in FIG. 3). However, the weld portion indicated by W is only an exemplary position and is not limited thereto. The welding shape and number of weld portions of the weld region 5572 may be modified. In order to secure a minimum welding area for welding the second electrode tab 430 and the contact portion 536, the minimum diameter of the weld region 5572 may be 2 pi (where pi is a distance in mm). In this case, the outer diameter of the connecting part 554 may be 5 pi. By adjusting the processing conditions, diameter of the welding region 5572 can be made smaller or larger.

The fuse region 5574 may be provided integrally with the weld region 5572. The fuse region 5574 may be provided in various shapes such as a square, a triangle, an inverted triangle, a circle, an oval, a semicircle, etc. When the fuse region 5574 is implemented in various shapes, a portion thereof may be shaped to overlap the weld region 5572. For example, the fuse region 5574 is a square is shown in the drawing.

When the temperature rises due to high resistance caused by overcurrent, the fuse region 5574 may melt and break. Since the fuse region 5574 has a smaller width than the diameter of the lower cap 550, the fuse region 5574 may melt and break first. As an example in the embodiment of FIG. 5, the width (L1, the left-right width on the basis of FIG. 5) of the fuse region 5574 may be the same as the diameter of the weld region 5572. For example, the minimum width (L1) of the fuse region 5574 may be 2 mm.

When the fuse region 5574 is blown, the weld region 5572 welded to the second electrode tab 430 is also separated from the lower cap 550. Since the lower cap 550 is welded to the vent plate 530 to be electrically connected, the electrical connection to the second electrode tab 430 is cut off when the fuse region 5574 is blown. That is, when the fuse region 5574 is blown, the current path connecting the second electrode tab 430 to the lower cap 550, and to the vent plate 530 is cut off. That is, the lower cap 550 has a current blocking function due to temperature according to high current.

Meanwhile, the insulator 570 may be provided with an insulating material so that the vent plate 530 and the lower cap 550 are kept apart and insulated from each other. The insulator 570 may be placed between the second support part 553 of the lower cap 550 and the second portion 533 of the vent plate 530. The insulator 570 may have a circular ring shape with a constant width when viewed from above. In an example, the left-right width of the insulator 570 on the basis of FIG. 3 may be smaller than or equal to the width of the second support part 553. Likewise, in an example, the insulator 570 may be formed of, but is not limited to, polyethylene (PE), polypropylene (PP), polystyrene (PS), ethylene-vinyl acetate copolymer (EVA), or an equivalent thereof. The insulator 570 may be bonded to the vent plate 530 and the lower cap 550 by ultrasonic welding, laser welding, fusion welding, or the like.

Referring to FIG. 5, in a state in which the upper cap 510 and the vent plate 530 are coupled to each other, the gasket 590 may be installed in a form that wraps around the outside of the vent plate 530. The upper cap 510 and the vent plate 530 may be coupled to the can 100 by means of the gasket 590 and may be insulated from the can 100. The gasket 590 may be made of the same or similar material as the insulator 570.

Hereinafter, various modified embodiments of the above-described blocking part will be described (detailed descriptions of the same configuration and features as the above-described embodiments are omitted).

FIGS. 6 to 12 are plan views of a lower cap and main parts according to other embodiments of the present disclosure.

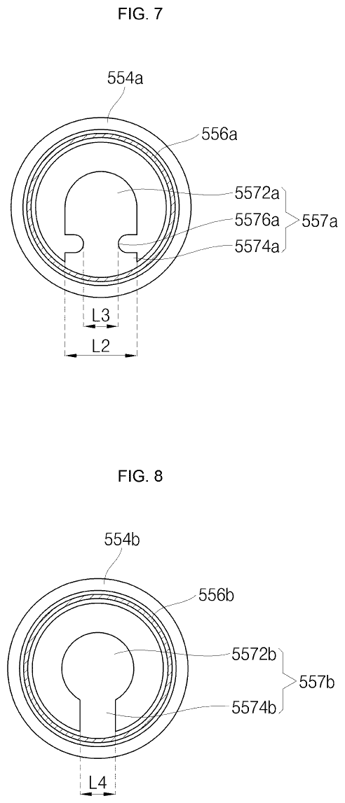

FIG. 6 is a plan view showing a lower cap 550a according to another embodiment of the present disclosure. FIG. 7 is an enlarged plan view showing a blocking part 557a of FIG. 6. Referring to FIGS. 6 and 7, the lower cap 550a may include a first support part 551, an inclined part 552, a second support part 553a, a connecting part 554a, and a blocking part 557a. The connecting part 554a may be provided with a notch 556a.

The blocking part 557a may have a shape in which a concave groove 5576a is located in a portion of the fuse region 5574 of the blocking part 557 of FIG. 5. The concave groove 5576a may be located on both the left and right sides of the fuse region 5574a, as illustrated in FIG. 7. A portion of blocking part 557a having, compared to other portions, a width reduced by providing the groove 5576a, may be broken faster than other portions when the temperature rises. That is, the region of blocking part 557a having the grooves 5576a may perform a fuse function, breaking faster than other regions. This narrower section of 557a, compared to other portions, which has a width reduced by providing the groove 5576a, may be defined as a bridge. On the basis of FIG. 7, the width (L3, the left-right length) of the bridge may be smaller than the width (L2) of another portion of the fuse region 5574a. In an example, when the width (L2) of the fuse region 5574a in the left-right direction is 2 mm, the width (L3) of the bridge may be 1 mm.

FIG. 8 is a plan view showing a blocking part 557b according to another embodiment of the present disclosure. The blocking part 557b may include a fuse region 5574b extended from the connecting part 554b, and a weld region 5572b extended from the fuse region 5574b. In an example, the fuse region 5574b may be a rectangular region having a width (L4) smaller than a diameter of the weld region 5572b. The weld region 5572b may be a circular region connected to an end of the fuse region 5574b. In an example, the left-right width (L4) of the fuse region 5574b may be 1 mm.

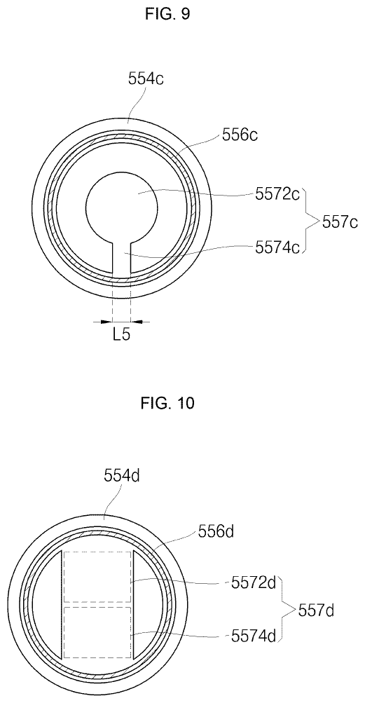

FIG. 9 shows a shape of the blocking part 557b of FIG. 8, in which only the left-right width (L5) of the fuse region 5574c is narrow. That is, the blocking part 557c of FIG. 9 may include a circular weld region 5572c and a rectangular fuse region 5574c. The left-right width (L5) of fuse region 5574c may be 0.5 mm.

In the above-described embodiments of FIGS. 4 to 9, the blocking parts 557 to 557c have a open ended shape extending from one side of the connecting part 554 and having an opening on the other side. The blocking parts 557 to 557c may also have a shape configured to allow one side and the other side of the connecting part 554 to connect.

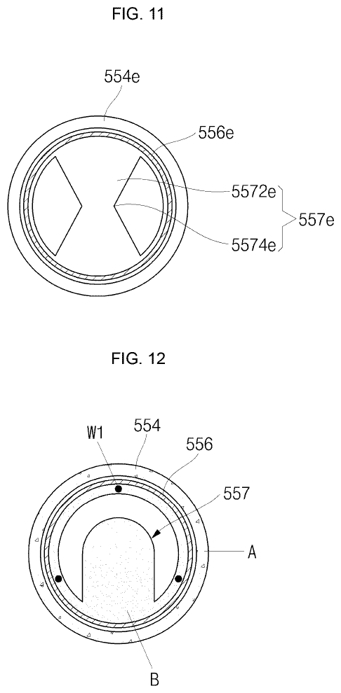

FIGS. 10 and 11 are plan views showing a shape in which the blocking part 557d is connected from one side to the other side of the connecting part 554d.

The blocking part 557d according to FIG. 10 may have a shape in which the weld region 5572d and the fuse region 5574d are not separately divided. However, a zone may be arbitrarily divided and a partial region may be designated as a weld region 5572d. The remaining region (with the exception of the weld region 5572d) may become the fuse region 5574d. However, the fuse region 5574d is merely designated by arbitrarily dividing a zone, and both the fuse region 5574d and/or the weld region 5572d may perform a fuse function by breaking when the temperature rises.

The blocking part 557e according to FIG. 11 may have a concave shape in which a central region in the blocking part 557d of FIG. 10 is roughly triangular. That is, the blocking part 557e according to FIG. 11 may have a roughly hourglass shape. In the blocking part 557e of FIG. 11, a zone may also be arbitrarily divided, and a partial region may be designated as a weld region 5572e. The remaining region, excluding the weld region 5572e, may become a fuse region 5574e. Here, the fuse region 5574e may include a concave region compared with other portions. The concave region is smaller than other portions, so it may be the first to break when the temperature rises, thereby functioning as a fuse. However, the fuse region 5574e is merely designated by arbitrarily dividing a zone, and both the fuse region 5574e and/or the weld region 5572e may perform a fuse function by being blown when the temperature rises.

In the above-described embodiments, examples in which the weld regions are semicircular or circular have been described. However, the weld region may be provided in various shapes including semi-elliptical, elliptical, triangular, and/or rectangular shapes. In addition, examples in which the fuse region has a diameter equal to or smaller than the diameter of the weld region have been described, but the fuse region may have a larger width than the weld region.

The width of an exemplary fuse region may range from 0.5 to 3 mm as shown below. The width of the fuse region may be adjusted so that the fuse function can be performed at a time required. In an example, when the blocking part 557 is designed to be blown after 60 seconds of heat generation due to high current generation, the width of the fuse region 5574 may be set to 1 mm to 2 mm.

| Width (mm) | Operating time (sec) |
|---|---|
| 0.5 | 40 |
| 0.75 | 51 |
| 1.0 | 60 |
| 2.0 | 67 |
| 3.0 | 77 |

(Operating time of fuse region under the conditions of aluminum in the material of blocking part and 50 A (ampere) in the current amount)

If the width of a fuse region is too small, the current may be cut off before a desired time is reached. Likewise, if the width of a fuse region is too large, notches may be ruptured due to the increase in internal pressure of a secondary battery before the fuse region is blown, thus cutting off the current. Taking this into account, the width of the fuse region may be set to cut off the fuse region at a desired operating time (Here, the operating time means a time until the fuse region is blown).

In addition, the operating time of the fuse region may be changed by changing the type of metal that constitutes the blocking part. FIG. 12 is a plan view showing a blocking part according to another embodiment of the present disclosure. As illustrated in FIG. 12, the blocking part 557 may be made of a different metal material from a region (A) of a connecting part 554. Here, a region around the blocking part 557, including the blocking part 557, may be made of different materials. A portion made of different materials, including the blocking part 557 and a partial region around the blocking part 557, is indicated by B in FIG. 12. In an example, the material of the region A) of the connecting part 554 may be aluminum, and the material of the region (B) may be copper. A partial region around the blocking part 557 may be a circular ring-shaped and at least partially surround the blocking part 557. This region can be used for welding and combining the connecting part 554 and the blocking part 557 together. In order to combine the blocking part 557 with the connecting part 554, the region around the blocking part 557 may overlap and be welded to the connecting part 554. An exemplary welding position is indicated by W1 in FIG. 12. The welding position may include multiple welding positions. When the blocking part 557 is provided with copper, the operating time may vary depending on the width of the fuse region as shown below.

| Width (mm) | Operating time (sec) |
|---|---|
| 0.5 | 30 |
| 0.75 | 40 |
| 1.0 | 50 |
| 2.0 | 60 |
| 3.0 | 70 |

(Operating time of fuse region under the conditions of copper in the material of blocking part and 50 A (ampere) in the current amount)

That is, by changing the material of the blocking part 557, the operating time (current blocking time) of the fuse region may be additionally adjusted. Depending on the material of the blocking part 557, the operating time of the fuse region may be shortened or lengthened.

As described above, since a notch is provided in a vent plate and a blocking part is provided in a lower cap, a current blocking function which functions according to temperature can be provided, while also maintaining the current blocking function of a conventional vent that breaks according to the increase in the internal pressure. That is, both a current blocking function which breaks according to internal pressure and a current blocking function which breaks according to temperature can be provided with a single cap assembly configured as disclosed herein.

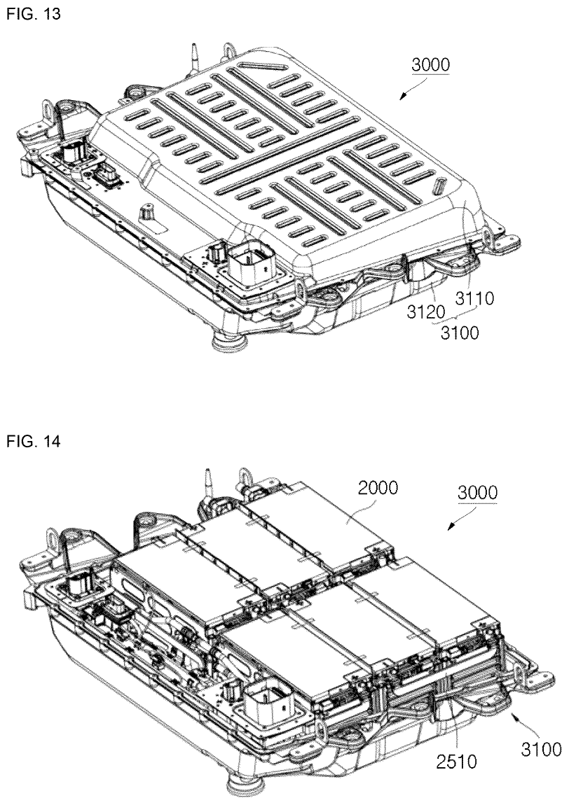

The secondary batteries according to the above-described embodiments can be used to manufacture a battery pack (The reference numerals of the configurations to be described below are reference numerals that apply only to the corresponding drawings). FIGS. 13 and 14 are perspective views showing a battery pack 30000 including an exemplary secondary battery.

Referring to FIGS. 13 and 14, the battery pack 3000 may include a plurality of battery modules 2000 and a housing 3100 for accommodating the plurality of battery modules 2000. For example, the housing 3100 may include first and second housings 3110 and 3120 coupled in opposite directions through the plurality of battery modules 2000. The plurality of battery modules 2000 may be electrically connected to each other by using a bus bar 2510, and the plurality of battery modules 2000 may be electrically connected to each other in a series/parallel or series-parallel mixed method, thereby obtaining desired (e.g., required) electrical output. In the drawings, for convenience, components such as busbars for the electrical connection of battery cells, cooling units, and external terminals are omitted. In some examples, the battery pack (300) may be installed in a vehicle. The vehicle can be, for example, an electric vehicle, a hybrid vehicle, or a plug-in hybrid vehicle. The vehicle may include a four-wheel vehicle or a two-wheel vehicle.

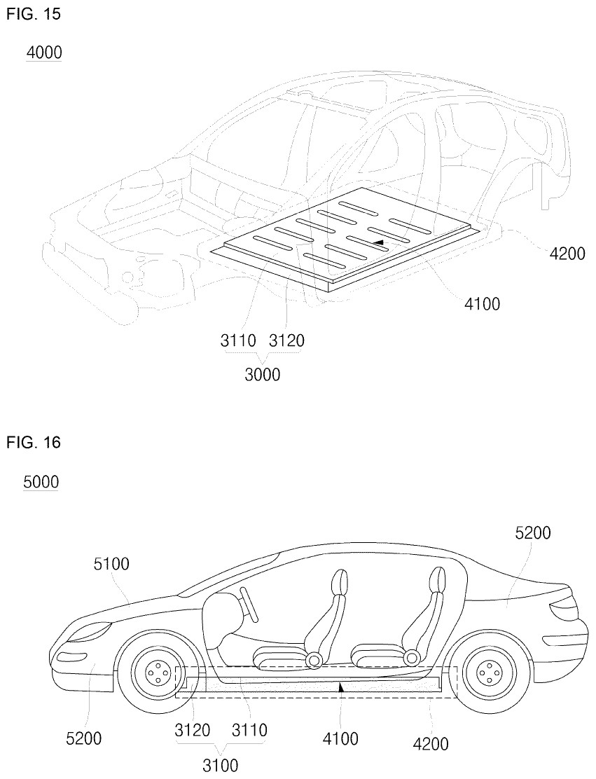

FIGS. 15 and 16 are perspective and side views of automobiles 4000 and 5000 including an exemplary battery pack 3000 according to the present invention. In FIG. 15, a battery pack 3000 may include a battery pack cover 3110, which is a part of a vehicle underbody 4100 and may correspond to the first housing, and a pack frame 3120, which is disposed under the vehicle underbody 4100 and may corresponding to the second housing. The battery pack cover 3110 and the pack frame 3120 may be integrally formed with a vehicle floor 4200. The vehicle underbody 4100 separates the inside and outside of a vehicle, and the pack frame 3120 may be disposed outside the vehicle.

In FIG. 16, a vehicle 5000 may be formed by combining additional parts, such as a hood 5100 in front of the vehicle 5000 and fenders 5200 respectively located in the front and rear of the vehicle 5000 to a vehicle body pars 4000. The vehicle 500 may include the battery pack 3000 including the battery pack cover 3110 and the pack frame 3120, and the battery pack 3000 may be coupled to the vehicle body part 4000.

While the foregoing embodiment has been described to practice the present disclosure, it should be understood that the embodiment described herein should be considered in a descriptive sense only and not for purposes of limitation, and various changes in form and details may be made therein without departing from the spirit and scope of the disclosure.

What is claimed is:

1. A secondary battery comprising:
a cylindrical can having a first end that is open and a second end that is closed;
an electrode assembly accommodated in the cylindrical can; and
a cap assembly including:
an upper cap disposed at the first end of the cylindrical can;
a lower cap spaced from the upper cap and disposed to face the electrode assembly;
a vent plate disposed between the upper cap and the lower cap and surrounding an edge of the upper cap;
an insulator made of an insulating material and inserted between the vent plate and the lower cap; and
a gasket made of an insulating material and inserted between the vent plate and the cylindrical can,
wherein the lower cap comprises:
a blocking part having a weld region that is welded to the vent plate; and
a fuse region configured to melt at a preset temperature, the fuse region being separate from the weld region.

2. The secondary battery as claimed in claim 1, wherein the blocking part is provided as a plurality of block parts.

3. The secondary battery as claimed in claim 1, wherein the upper cap has a disk shape and includes:
a first region surrounded by the vent plate;
a second region protruding in the opposite direction of the electrode assembly; and
a third region connecting the first region and the second region, with a plurality of discharge holes extending through the third region.

4. The secondary battery as claimed in claim 3, wherein the vent plate has a disk shape and includes:
a first portion positioned below the second region;
an inclined surface extending upward from the first region;
a second portion extending outward from the inclined surface and contacting a lower surface of the first region;
a third portion extending from the second portion and contacting a side surface of the first region; and
a fourth portion extending from the third portion and contacting an upper surface of the first region.

5. The secondary battery as claimed in claim 4, wherein the lower cap includes:
a first support part positioned below the first portion;
an inclined part extending upward from the first support part;
a second support part extending outward from the inclined part and positioned below the second portion; and
a connecting part extending inward from the first support part.

6. The secondary battery as claimed in claim 5, wherein a thickness of the connecting part is less than a thickness of the first support part.

7. The secondary battery as claimed in claim 6, wherein:
the fuse region extends from a side of the connecting part; and
the weld region extends from the fuse region.

8. The secondary battery as claimed in claim 7, wherein the vent plate further includes a contact portion protruding from the lower surface of the first portion toward the lower cap.

9. The secondary battery as claimed in claim 8, wherein the contact portion is welded to the weld region, such that the contact portion is electrically connected to the weld region.

10. The secondary battery as claimed in claim 9, wherein the electrode assembly further includes:
a first electrode tab electrically connected to a first electrode plate; and
a second electrode tab electrically connected to a second electrode plate of the electrode assembly.

11. The secondary battery as claimed in claim 10, wherein:
the first electrode tab is electrically connected to the closed end of the can; and
the second electrode tab is welded to the weld region of the blocking part, such that the second electrode tab is electrically connected to the weld region.

12. The secondary battery as claimed in claim 11, wherein a portion where the contact portion and the weld region are welded and a portion where the second electrode tab and the weld region are welded does not overlap each other.

13. The secondary battery as claimed in claim 11, wherein in the blocking part, the weld region, and the fuse region have a same width.

14. The secondary battery as claimed in claim 13, wherein in the blocking part, a portion of the fuse region has a smaller width than the weld region.

15. The secondary battery as claimed in claim 10, wherein the weld region and the fuse region are provided as one piece.

16. The secondary battery as claimed in claim 5, wherein the blocking part extends from one end to the other end of the connecting part and connects to the connecting part.

17. The secondary battery as claimed in claim 16, wherein a portion of the blocking part has a smaller width than other regions.

18. The secondary battery as claimed in claim 5, wherein at least one notch is provided in the first portion of the vent plate and the connecting part of the lower cap.

19. The secondary battery as claimed in claim 5, wherein the blocking part is made of a different material from the lower cap.

20. The secondary battery as claimed in claim 5, wherein the blocking part and a portion of the connecting part including the blocking part are made of a different material than the lower cap.

21. The secondary battery as claimed in claim 20, wherein the portion of the connecting part including the blocking part overlaps the connecting part to then be welded.
